(19) United States
(12) Patent Application Publication
(10) Pub. No.: US 2011/0191014 A1
(43) Pub. Date: Aug. 4, 2011

(54) MAPPING INTERFACE WITH HIGHER ZOOM LEVEL INSET MAP

(75) Inventors: Shuangtong Feng, Kirkland, WA (US); Chad Raynor, Seattle, WA (US); Andrew Paul McGovern, Seattle, WA (US); Michael John Narayan, Seattle, WA (US)

(73) Assignee: Microsoft Corporation, Redmond, WA (US)

(21) Appl. No.: 12/700,260

(22) Filed: Feb. 4, 2010

(51) Int. Cl. G09G 5/00; G01C 21/00

(52) U.S. Cl. 701/200; 345/660

(57) ABSTRACT

Maps of a particular location are often generated with an inset area map, rendered in an inset region of the location map, of the general area including the location at a lower zoom level than the location map. However, this presentation may be disadvantageous in some scenarios (e.g., the where a user is interested in examining the extended area around the location, the area between two locations, or the spatial layout of the locations.) Instead, a composite map may be generated comprising an area map at an area map zoom level, and an inset location map rendered in an inset region of the location map and illustrating a location at a higher zoom level than the area map zoom level. Such composite maps may also be requested programmatically of a map generating service, and may be provided in an automated manner for use in an application.

### BACKGROUND

Within the field of computing, many scenarios may involve a displaying for a user of maps involving one or more locations that are of interest to the user. A device of the user (such as a global positioning service device, a mobile phone, or a portable or desktop computer) may receive a request from the user to display a map of the location, and may either select a map from an internal map set (such as a database) or may contact a map server to request and receive the desired map. The map of the location(s) may then be displayed for the user on a display of the device. While displaying a (comparatively large) map of the location of interest, it may also be desirable to display an inset map of the area, e.g., a small inset map overlapping a portion of the location map and showing, at a lower zoom level as compared with the location map, the general area including the location. The inclusion of an inset map of the general area may assist the user in identifying the position of the location within the general area and the scale and boundaries of the area viewed in the main map.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the displaying of an inset map of a general area with a map of a location may present some advantages, some disadvantages may also arise from this presentation. As a first example, the user may be interested in examining the general area and the spatial layout of one or more locations within the general area than in the mapping of a particular location (e.g., the distances between locations, the area between locations, and the extended area around a location.) These interests may not be well-served by presenting the general area as an inset map within a larger map of a location, because the allocation of the presentation may be too heavily focused on the location and may depict the general area in an inadequately small manner. As a second example, if the maps are involved in a routing scenario (such as a directional mapping application presented on a global positioning service (GPS device), one or more routes among various locations may be illustrated on the inset area map, and the portion of the route through a particular location may be illustrated on the location map; however, if the illustrated route is condensed into the small inset area map, it may be difficult for a user to understand how the portion of the route illustrated for the location relates to the corresponding portion of the route shown on the inset area map.

Alternative techniques may be utilized to present maps that may ameliorate some of these disadvantages and/or present additional advantages in particular scenarios. According to these techniques, a composite map may be generated featuring a comparatively large area map including a location of interest, and an inset map of the location, presented at a higher zoom level than the zoom level of the area map, that is generated and rendered over a portion of the area map. Thus, instead of presenting the area map as a small inset within a location map, a comparatively large area map may be presented with the location illustrated in more detail within an inset map of the area map. This presentation may adjust the emphasis on different aspects of the mapped areas; e.g., while less detail about the location may be discernible from the inset location map, more information about the area may be discernible from the area map. In some scenarios, this adjusted emphasis may be advantageous. For example, more information may be presented in the area map regarding the spatial layout of various locations, the area between locations, and the extended area around each location than in techniques involving an inset area map. This presentation may also be advantageous for displaying maps in relation to routing scenarios, where displayed a comparatively large map may promote the contextual correspondence of the presented route with a routing instruction presented with a location. In particular, these presentations may be generated by a service, such as an application programming interface (API) provided locally or exposed over a network as a web service, wherein users may submit requests for a map including a location of interest and, and where the service generates and presents the maps according to these techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation of a location map with an inset area map.

FIG. 2 is an illustration of some exemplary presentations of location maps with inset area maps and some disadvantages arising therefrom.

FIG. 3 is an illustration of some exemplary presentations of area maps with inset location maps of locations in accordance with the techniques presented herein.

FIG. 4 is an illustration of an exemplary scenario featuring a presentation of an area map with an inset location map of a location in accordance with the techniques presented herein.

FIG. 5 is a flow chart illustrating an exemplary method of presenting a map including a location to a user.

FIG. 6 is a component block diagram illustrating an exemplary system for presenting a map including a location to a user.

FIG. 7 is an illustration of an exemplary computer-readable medium comprising processor-executable instructions configured to embody one or more of the provisions set forth herein.

FIG. 8 is an illustration of an exemplary scenario featuring a generation, scaling, and trimming of an inset location map utilizing a map set comprising map tiles.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve the presentation of various types of maps drawn from a map set, such as a database of map images of a mapped area. As a first example, a mapping application may be executed on a robust device such as a personal computer, such as a workstation or a portable computer, or on a more limited device, such as a smartphone or a global positioning service (GPS) receiver, and may generate maps of an area to serve various ends of the user, such as surveying a region of interest or finding particular locations within an area. As a second example, a navigation application may be capable of identifying various routes among sets of locations, such as driving routes, biking routes, walking or jogging routes, and waterway routes, and may provide such routes to serve various ends of the user, such as planning trips or calculating distances between locations. In these scenarios, the map set may be stored locally (such as in a static or volatile memory of the device), or may be stored remotely, and the service may be implemented to provide maps on request (e.g., by a user specifying a location of interest, or by an application or another device serving a user.)

Such services may generate many types of map in this context. One such type of map is a map depicting the area of a location, such as a landmark, a neighborhood, a city, or a state, and having an inset depicting a larger area including the location. The inset area map may reveal the positioning of the location within a general area, such as by showing the neighborhood wherein a landmark location is located, a city wherein a neighborhood location is located, a state wherein a city location is located, or a country or continent wherein a state is located. The inset area map is often positioned in a corner of the location map, such as the upper-right corner, and illustrates an extended area surrounding the location at a lower zoom level than the zoom level of the location map. Additionally, the inset area map may present a simplified view of the area including the location (e.g., by removing or diminishing non-major map features that are not of interest to the user in the presentation of the inset area map), and/or presents an indicator of the location shown in the location map (e.g., by rendering into the inset area map a rectangle indicating area boundaries comprising the borders of the location map.)

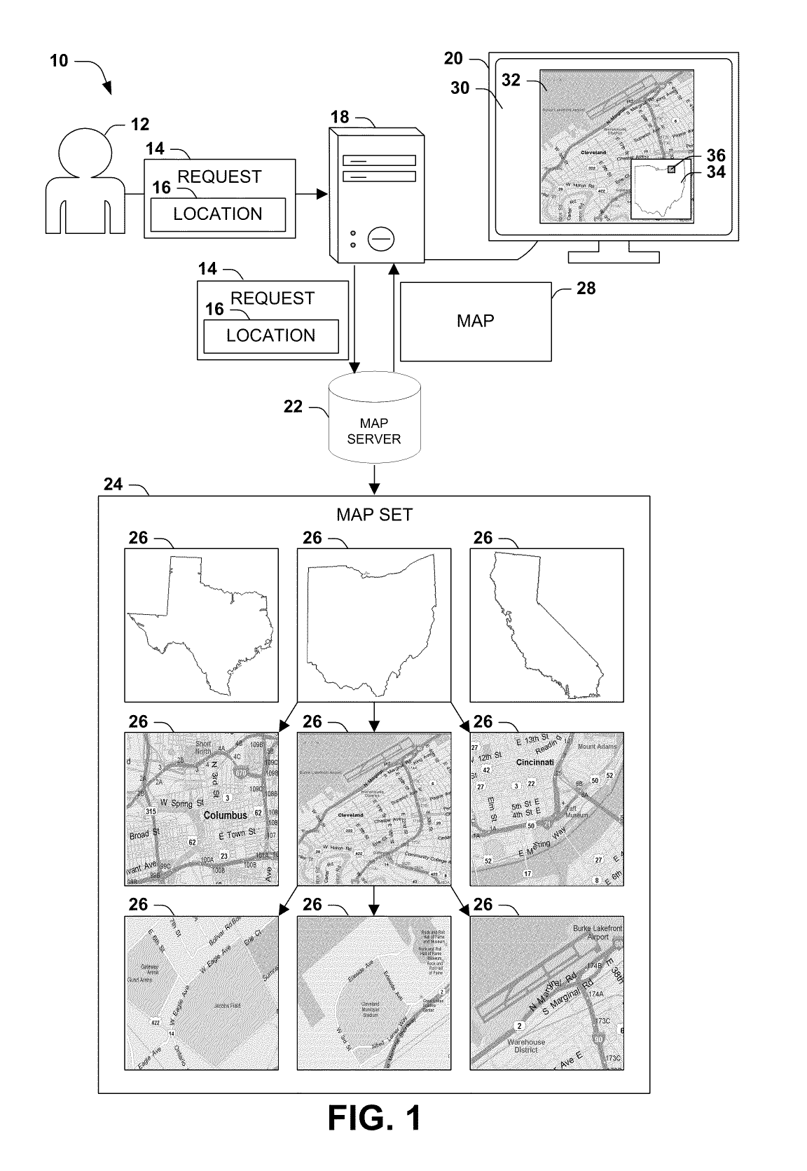

FIG. 1 presents an exemplary scenario 10 illustrating a presentation 30 of a map 28 to a user 12. In this exemplary scenario 10, the user 12 operates a device 18 having a display component 20, and submits to the device 18 a request 14 for a map of a location 16, comprising the downtown area of the city of Cleveland in the state of Ohio of the United States. In order to fulfill this request 14, the device 18 may forward the request 14 to a map server 22, which may have access to a map set 24 comprising maps 26 of various mapped areas. The map set 24 may comprise maps 26 of many zoom levels, such as maps 26 of various states (such as the state of Texas, the state of Ohio, and the state of California); maps 26 of various cities within such states (such as the cities of Columbus, Cleveland, and Cincinnati located within the state of Ohio); and maps 26 of various landmarks within such cities (such as the landmarks of a baseball stadium, a football stadium, and an airport within the city of Cleveland.)

In order to fulfill the request 14 of the user 12, the map server 22 may select maps 26 from the map set 24 that include the location 16 specified by the user 12, and may generate many types of maps therefrom. In this exemplary scenario 10, the map server 22 generates a composite map featuring a location map 32 illustrating (at a comparatively high zoom level and with a considerable amount of detail) the location 16 specified by the user 12), and also featuring an inset area map 34 illustrating (at a comparatively low zoom level and with considerably less detail than the location map 32) the extended area around the location 16. In the exemplary scenario 10 of FIG. 1, the user 12 has specified in the request 14 a location 16 comprising the downtown area of the city of Cleveland. The map server 22 may therefore generate and present to the user 12 a composite map 30, comprising a location map 32 of the downtown area of the city of Cleveland (as specified by the user 12) at a high zoom level illustrating considerable detail about the location 16, and also an inset area map 34 illustrating the state of Ohio that contains the city of Cleveland. The inset area map 34 may be positioned to overlay a corner of the location map 32 (and it may be advantageous to positing the inset area map 34 so as to reduce the obscuring of significant aspects of the location map 32, and may also include a marker 36 indicating the portion of the inset area map 34 that is included in the location map 32. By rendering the composite map 30 in this manner, the map server 22 may provide to the user 12 a map 28 that both illustrates the specified location 16 in considerable detail, and also indicates the context of the location map 32 by indicating the displayed area on the area inset map 34. Moreover, the device 18 may present the composite map 30 to the user 12 as a static map (e.g., as a static image), as a dynamic or interactive map (e.g., as a map that the user may alter to pan, zoom in, annotate, or cross-reference the composite map 30 with other resources), or as input to a mapping application executing on the device 18.

The composite map 30 generated and presented in the exemplary scenario 10 of FIG. 1 may present some advantages. As a first example, the composite map 30 presents a comparatively large location map 32 that presents considerable information about the locale of the location 16, which may be helpful, e.g., if the user 12 is endeavoring to study or explore the location 16 at length. As a second example, the composite map 30 also presents the inset area map 34 that promotes the contextual understanding of the user 12 regarding the positioning of the location 16 within an extended area, such as the positioning of an illustrated portion of downtown Cleveland within the state of Ohio. Therefore, for some ends of the user 12, a composite map 30 generated and presented in the manner of the exemplary scenario 10 of FIG. 1 may be sufficient and helpful. However, other ends of a user 12 for a composite map 30 may be inefficiently promoted, or even hampered, by the presentation of a composite map 30 in the manner illustrated in FIG. 1.

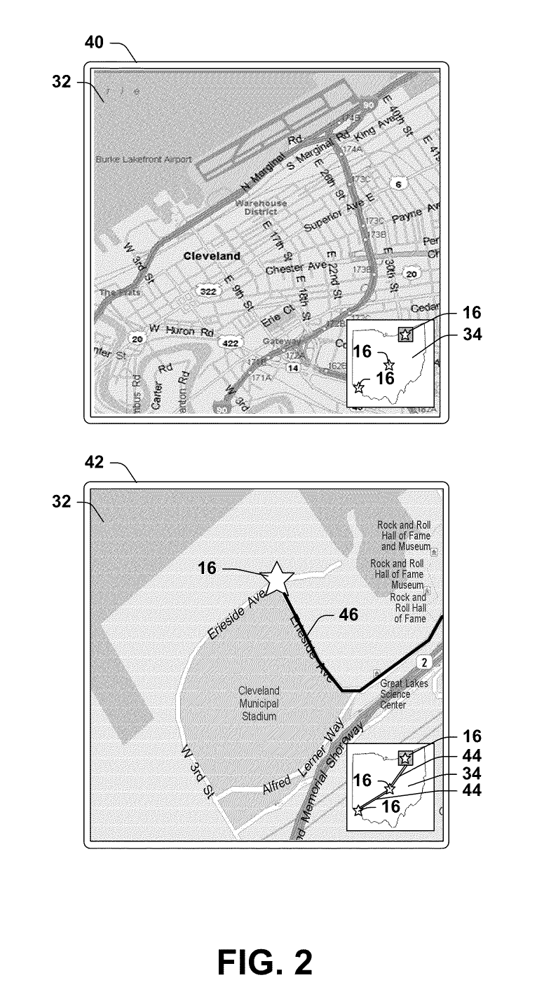

FIG. 2 presents some exemplary presentations of composite maps 30 that may be disadvantageous or obstructive of the ends of the user 12 in requesting the composite map 30. A first presentation 40 illustrates a comparatively large location map 32 of a location 16 representing a downtown area of Cleveland, and an inset area map 34 of a comparatively small size rendered upon the location map 32 and representing an area (the state of Ohio) including several locations 16 (large cities in Ohio, including Cleveland, Columbus, and Cincinnati.) This first presentation 40 may have some advantages, including the displaying of the location 16 as a comparatively large map that illustrates significant detail of the location 16 and the positioning of the location 16 within the area (i.e., the positioning of the city of Cleveland within the state of Ohio.) However, several disadvantages may also exist with regard to certain aspects of the first presentation 40, in particular because of the comparatively small size of the inset area map 34. As a first example, the inset area map 34 may be too small to identify with accuracy the positioning of a location 16 with respect to other locations 16 and the area, or the distance between two locations 16. While approximate guesses may be achieved, accurate identification of these aspects may be unattainable with a small inset area map 34. As a second example, the small size of the inset area map 34 may not permit details about the area except the locations 16, so it may be difficult to determine additional information of the area, such as the extended region of a location 16 (beyond the boundaries of the location map 32) and the area between two locations 16. As a third example, it may be difficult to display many locations 16 on the inset area map 34 without cluttering the inset area map 34. As a fourth example, the presentation 40 might comprise a dynamic or interactive map that permits the user 12 to select a location 16 to be displayed in the location map 32 by selecting a location 16 shown on the inset area map 34 (e.g., by clicking on the location 16 with a pointing device, such as a mouse); however, the comparatively small size of the inset area map 34 may cause difficulty in selecting a desired location 16, particularly if two or more locations 16 are close on the inset area map 34.

FIG. 2 also includes a second presentation 42 of a location map 32 of a location 16 (e.g., a sports stadium within the city of Cleveland) and a comparatively small inset area map 34 rendered thereupon and representing an area including the location 16 (e.g., the state of Ohio.) The second presentation 42 also illustrates a route 44, comprising a set of routing directions 46 that connect the locations 16 in a stepwise manner. The location map 32 may present a particular routing direction 46, such as the start of the route 44. However, because the inset area map 34 is of a comparatively small size, it may be difficult to determine how the routing direction 46 relates to the route 44. In particular, the inset area map 46 may present the route 44 in an oversimplified manner, which may not logically connect with the routing location 46 illustrated on the location map 32 (particularly if a comparatively large difference exists in the zoom levels of the location map 32 and the inset area map 34.) For example, in this second presentation 42, the routing direction 46 at the location 16 exits the boundaries of the location map 32 to the east, but on the inset area map 34, the routing direction 46 through the location 16 appears to exit the location 16 to the southwest. Additionally, the comparatively large size of the location map 16 the second presentation 42 may be advantageous if the user 12 is focused on receiving a per-location routing direction 46 at the location 16 (such as using the location map 32 during navigation of a vehicle in order to traverse the route 44), but may be disadvantageous if the user 12 is focused on examining the entire route 44 or a portion of many routing directions 46 (e.g., the user 12 may be familiar with the area, and may be less interested in per-location routing directions 46 than achieving a holistic understanding of the entire route 46 among two or more locations 16.)

In accordance with these and other disadvantages of the first presentation 40 and the second presentation 42 of FIG. 2, alternative techniques may be utilized to present a map that may be comparatively advantageous for particular ends of the user 12. As a first example, rather than presenting the map as a comparatively large location map 32 and a comparatively small area inset map 34 rendered thereupon, the map may comprise a comparatively large area map including a set of locations 16 and a comparatively small location inset map of a particular location 16. A map server 22 may be configured to, using the map set 24, select one or more maps illustrating a particular area including a location 16 and generate a (comparatively large) area map, to select one or more maps illustrating a location 16 at a higher zoom level than the zoom level of the area map and generate an inset location map, and to render the inset location map over the a portion of the area map. The map server 22 may also be configured not only to provide maps directly to users 12 (e.g., as an image or as a component of a web page), but may also receive automated requests (such as programmatic requests) and/or provide composite maps in a manner that automated processes may easily utilize (e.g., as an object delivered within an Extensible Markup Language (XML) wrapper including metadata and that may be transmitted over a network via the Simple Object Access Protocol (SOAP).)

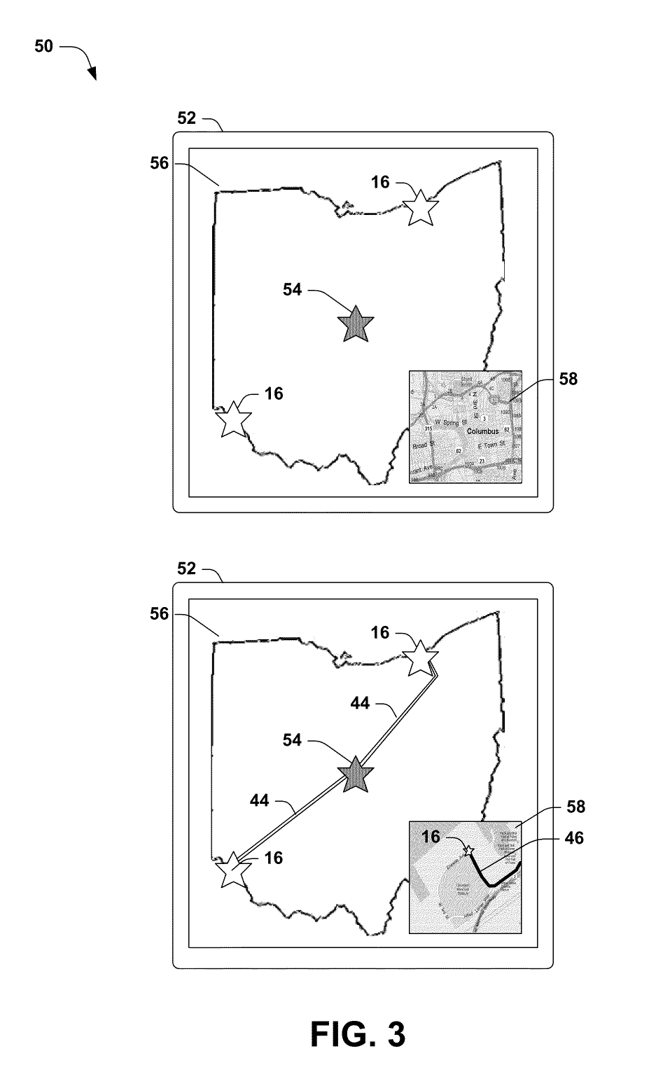

FIG. 3 presents two examples of a composite map 52 that may be generated according to the techniques presented herein, comprising an area map 56 including a particular location 54 (possibly including other locations 16), and an inset location map 58 of the location 54 that is presented at a higher zoom level than that of the area map 56. The presentation of a composite map 52 may be desirable, e.g., for a holistic examination of the area or the locations. As illustrated by the first composite map 52 of FIG. 50, the larger size of the area map 56 may be desirable for providing additional information about the area including the location 54, including a more accurate positioning of the locations 16 within the area (which may promote more accurate estimates by users 12 of distances therebetween). Although not shown, the larger size of the area map 56 (as contrasted with the inset area maps 44 of FIG. 2) may also include additional information in the area map 56 about the illustrated area, such as terrain or features in the area around a location 16 or between locations, without cluttering the presentation of the area map 56. The comparatively small inset location map 58 may serve to provide some additional detail about the selected location 54, but, in some scenarios, may reduce the presentation of information to the user 12 where detailed information provided in the location maps 16 of FIG. 2 may not be useful to the user 12. If presented as a dynamic or interactive map, the larger size of the area map 56 may also facilitate users 12 in selecting a location 16 to be displayed in the inset location map 58. The second composite map 52 of FIG. 3 illustrates additional advantages that may be achievable within a routing scenario by using the techniques presented herein. For example, this composite map 52 may present additional information about the route 44 through a particular location (e.g., the direction from which the route 44 exits a location 16, which may be difficult to discern from the inset location map 58), and/or may reduce the amount of information provided to the user 12 in illustrating a routing direction 46 within the area presented in the inset location map 58. These and other potential advantages may be achievable based on the techniques presented herein.

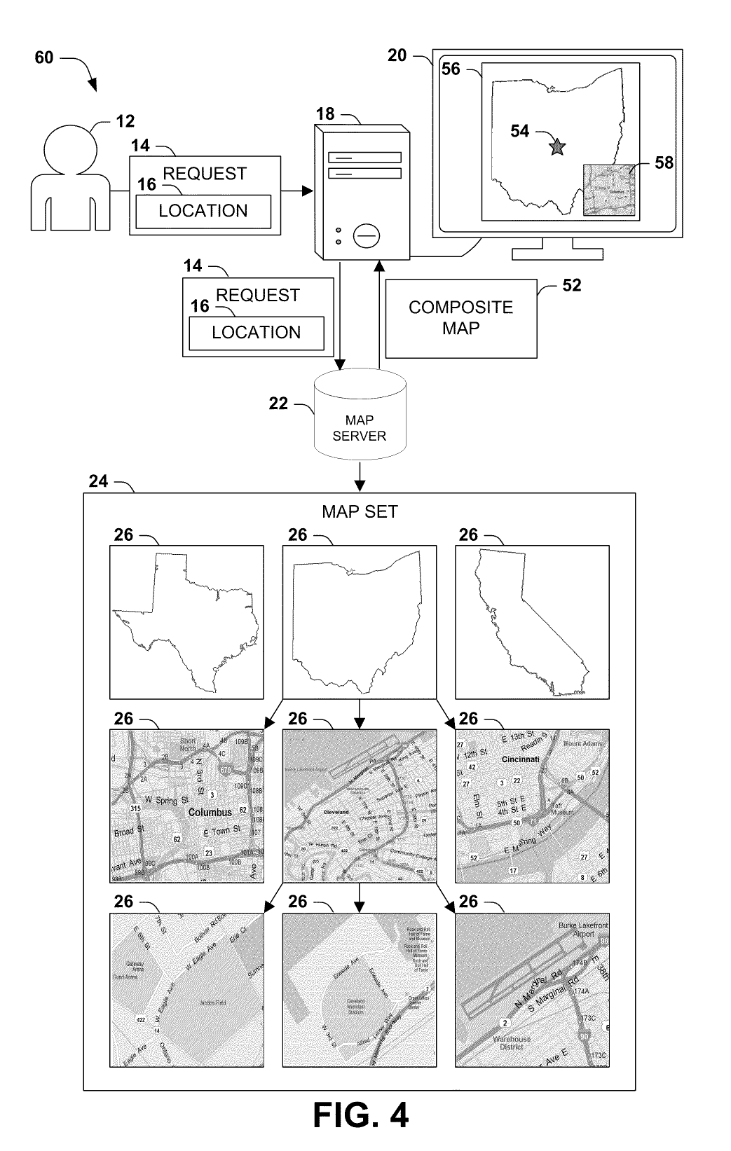

FIG. 4 presents an exemplary scenario 60 featuring the presentation of a composite map generated according to the techniques presented herein. In this exemplary scenario 60, a user 12 of a device 18 may generate a request 14 for a composite map featuring a particular location 16. The device 18 may forward the request 14 to a map server 22, which may generate a composite map 52 in the following manner. The map server 22 may retrieve from a map set 24 one or more maps 26 that together illustrate an area including the location 16 specified in the request 14, and may generate an area map 56 of the area (possibly including one or more location indicators 54 representing locations 16 specified by the user 12). The area map 56 may be generated from maps 26 illustrating the area at a particular area map zoom level, or from maps 26 illustrating the area at another zoom level may be scaled to match the area map zoom level. The map server may 22 also retrieve from the map set 24 one or more maps 26 that together illustrate the location 16, and may be selected from maps 26 at a particular inset location map zoom level or by scaling maps 26 at a different zoom level to match the inset location map zoom level, where the inset location map zoom level is higher than the area map zoom level. From the latter set of maps 26, an inset location map 58 may be generated at a zoom level that is higher than the zoom level of the area map 56 (thereby illustrating the location 16 in more detail than illustrated in the area map 56). The map server 22 may render the inset location map 58 over a portion (an “inset region”) of the area map 56, thereby generating a composite map 52 that illustrates an area including the location 16 (and possibly other locations 16) as a comparatively large map at a comparatively low zoom level, and that also illustrates the location 16 as a comparatively small map at a comparatively high zoom level. The composite map 52 may then be presented to the user 12 for presentation on a display component 20 of the device 18. Moreover, the map server 22 may be configured to receive the request 14 as a programmatic invocation of a service offered by the map server 22, and/or may present the composite map 52 to the device 18 of the user 12 in a programmatic manner, thereby facilitating the requesting and/or use of the composite map 52 by various automated processes operating on the device 18. By generating and presenting the composite map 52 comprising the area map 56 and the inset location map 58 (at a higher zoom level than that of the area map 56), the map server 22 may therefore satisfy the request 14 of the user 12 in a manner that may present some advantages over the presentation 30 illustrated in the exemplary scenario 10 of FIG. 1.

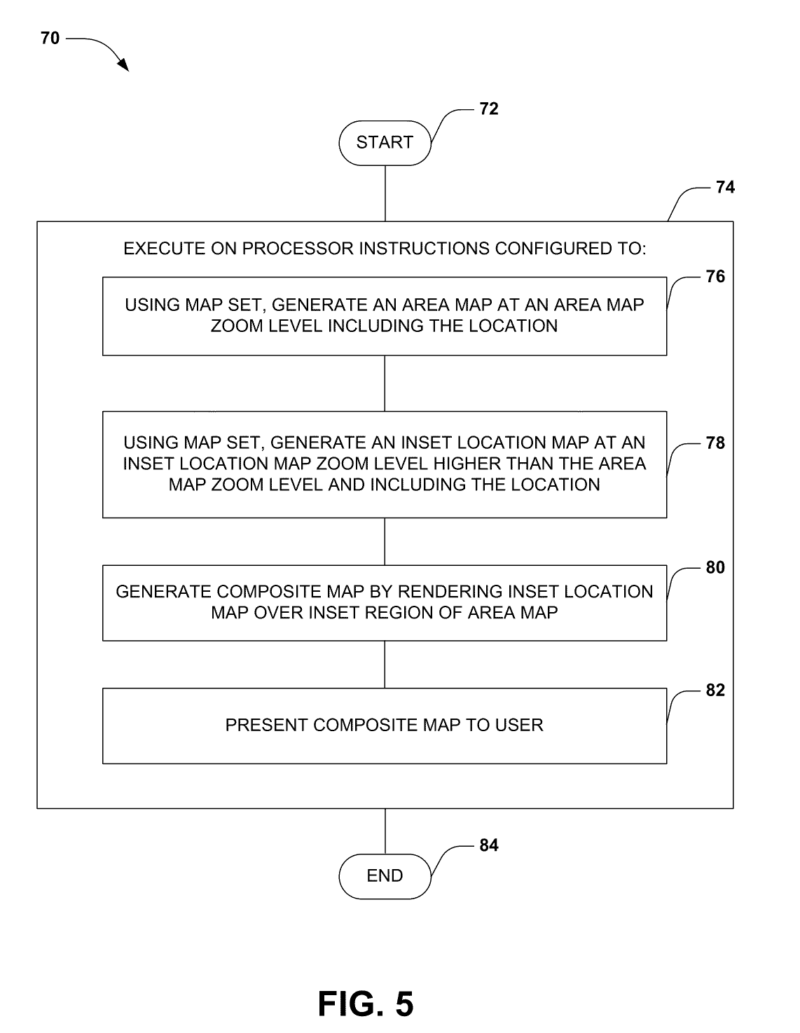

FIG. 5 presents a first exemplary embodiment of these techniques, illustrated as an exemplary method 70 of presenting a map including a location 16 to a user 12. The presenting may be performed, e.g., on a device 18 having a processor and a map set 24, and may be implemented as a set of instructions stored in a volatile or non-volatile memory of the device 18. The exemplary method 70 begins at 72 and involves executing 74 on the processor instructions configured to perform the techniques presented herein. In particular, the instructions are configured to, using the map set 24, generate 76 an area map 56 at an area map zoom level and including the location 16. The instructions are also configured to, using the map set, generate 78 an inset location map 58 at an inset map zoom level higher than the area map zoom level and including the location 16. The instructions are also configured to generate 80 a composite map 52 by rendering the inset location map 56 over an inset region of the area map 56, and to present 82 the composite map 52 to the user 12. Having generated and presented a composite map 52 of the location 16 requested by the user 12, the exemplary method 70 thereby achieves the techniques presented herein, and so ends at 84.

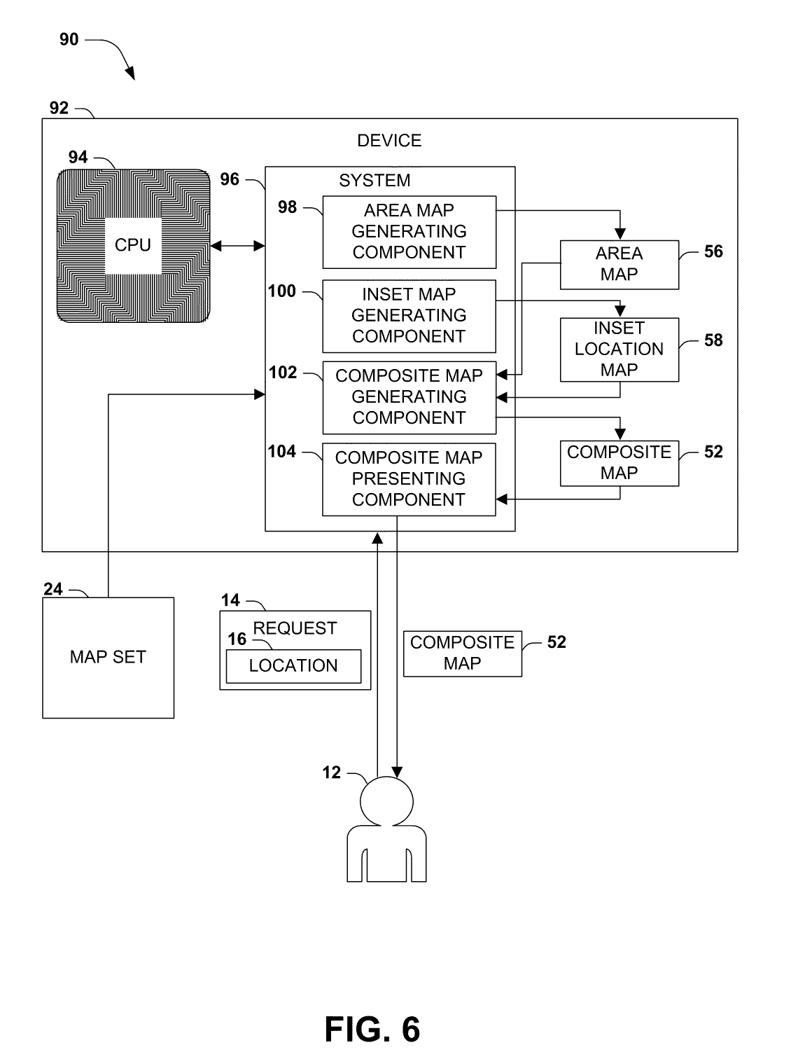

FIG. 6 presents a second exemplary embodiment of the techniques presented herein, illustrated as an exemplary system 96 operating within a device 92 having a processor 94 and having access to a map set 24 comprising maps 26 of a mapped area. The exemplary system 96 may be configured to, using the map set 24, present a map including a location 16 to a user 12. For example, the exemplary system 96 may be implemented as a set of instructions encoded in a volatile or non-volatile memory of the device 92 and executed by the processor 94 to perform the techniques presented herein. The exemplary system 96 comprises an area map generating component 98, which is configured to, using the map set 52, generate an area map 56 at an area map zoom level and including the location 16. The exemplary system 96 also comprises an inset location map generating component 100, which is configured to, using the map set 24, generate an inset location map 58 at an inset location map zoom level higher than the area map zoom level, and that includes the location 16. The exemplary system 96 also comprises a composite map generating component 102, which is configured to generate a composite map 52 by rendering the inset location map 58 over an inset region of the area map 56. The exemplary system 96 also comprises a composite map presenting component 104, which is configured to present the composite map 52 to the user 12 (e.g., by displaying the composite map 52 on a display component 20 attached to the device 92, by storing the composite map 52 as an object or file of the device 92, and/or by transmitting the composite map 52 to the user 12 over a computer network). In this manner, the exemplary system 96 may utilize the techniques presented herein to generate and present composite maps 52 to the user, such as those illustrated in FIG. 4.

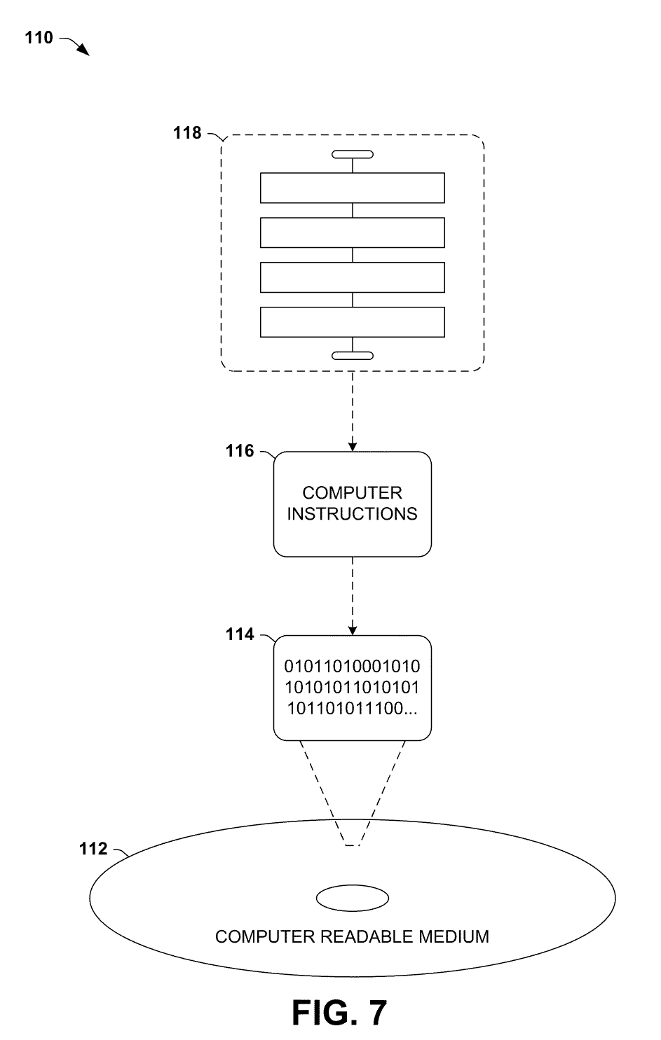

Still another embodiment involves a computer-readable medium comprising processor-executable instructions configured to apply the techniques presented herein. An exemplary computer-readable medium that may be devised in these ways is illustrated in FIG. 7, wherein the implementation 110 comprises a computer-readable medium 112 (e.g., a CD-R, DVD-R, or a platter of a hard disk drive), on which is encoded computer-readable data 114. This computer-readable data 114 in turn comprises a set of computer instructions 116 configured to operate according to the principles set forth herein. In one such embodiment, the processor-executable instructions 116 may be configured to perform a method of presenting a map including a location to a user, such as the exemplary method 70 of FIG. 5. In another such embodiment, the processor-executable instructions 116 may be configured to implement a system for presenting a map including a location to a user, such as the exemplary system 96 of FIG. 6. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques presented herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 70 of FIG. 5 and the exemplary system 96 of FIG. 6) to confer individual and/or synergistic advantages upon such embodiments.

A first aspect that may vary among embodiments of these techniques relates to the scenarios wherein these techniques may be utilized. As a first example, the techniques may be used in many types of applications involving maps, including surveying applications that simply display maps of different mapped areas; applications that locate and identify various locations 16 of interest to the user 12 within the mapped area; applications that select and display routes 44 among sets of locations 16; and applications that provide en-route routing directions 46 as a user 12 travels along a route 44. As a second example, such applications may utilize many types of maps of the mapped area in this context, including two-dimensional or three-dimensional maps; photorealistic maps or maps that have been abstracted in various ways (e.g., as cartoon representations, or as plain surfaces or line drawings); maps illustrated from different perspectives, such as a top (“bird's-eye”) view and a ground-level street map; and maps capturing different modalities that illustrate one or more features of the mapped area, such as elevation or water depth, terrain, temperature, navigable roads and/or waterways, traffic, weather, and demographics such as population density. Hybrid maps that illustrate two or more modalities may also be used with these techniques. Additionally, the area map 56 and the inset location map 58 may be presented as the same type of map, or may be presented as different types of maps (e.g., an area map 56 including a bird's-eye view of a location 16, and an inset location map 58 including a street view of the location 16 at a higher zoom level than the zoom level of the area map 56).

As a third example of this first aspect, the composite maps 52 may be generated and presented in a static manner, e.g., as a non-interactive image, or as a dynamic or interactive manner, e.g., as a panorama where the user 12 may adjust the viewing angle of the first-person perspective. A dynamic or interactive composite map 52 may permit tilting, panning, zooming, navigating, changing modalities, or otherwise adjusting the view of the area map 56 and/or the inset location map 58. Hybrid composite maps 52 may also be generated, e.g., a static composite map 52 of a location 52 that is associated with a reference to a dynamic or interactive composite map 52 including the location 16. For example, an embodiment of these techniques may generate and present to the user 12 a web page featuring a static composite map 52 (such as a static image) that includes a location 16, along with a hyperlink that, when activated, redirects the device 18 of the user 12 to a dynamic composite map 52 including the same location 16. This hybrid approach may be advantageous, e.g., for presenting to the user 12 a static composite map 52 quickly and with comparatively little expenditure of computing resources of the map server 22 and/or the device 18 of the user, including memory, processor usage, battery power, and network capacity, while also allowing the user 12 to access a dynamic or interactive map including the same location 16. Those of ordinary skill in the art may devise many scenarios wherein these techniques may be utilized.

A second aspect that may vary among embodiments of these techniques relates to variations in the architectures of such embodiments. As a first example, the map set 24 may be stored locally (e.g., on a non-volatile memory accessible to the map server 22, such as a hard disk drive, a solid-state storage device, or an optical disc), or may be accessible to the map server 22 via a computer network, such as the internet, a wired or wireless local area network, or a cellular network. As a second example, the map server 22 and the device 18 may comprise different devices, such as a webserver and a mobile device having a web client, or may be comprise the same device 18, where the map server 22 comprises a service provided to an application operating on the device 18.

As a third example of this second aspect, an embodiment may be configured to generate many types of composite maps 52 based on many types of requests 14. As a first variation, the user 12 may simply request a map of a location 16, and an embodiment may generate and present to the user 12 a static composite map 52 (such as a static image), or may generate a dynamic or interactive composite map 52 of the location 16. As a second variation, the user 12 may operate an application that issues the request 14 to the map server 22 including one or more locations 16, where the request 14 may be specified in a programmatic manner (e.g., by the application in an automated manner that permits automated requesting and retrieval of the composite map 52 for inclusion in the application, without involving the intervention of the user 12). The map server 22, utilizing an embodiment of the techniques presented herein, may expose a programmatic interface that accepts programmatically specified request 16 specifying a location 16, may generate a composite map 52 of the location 16 (including an area map 56 including the location 16 and an inset location map 58 presenting the location 16 at a higher zoom level than that of the area map 56) in response to the request 16, and may deliver it to the device 18 (e.g., via a network, system bus, or interprocess communication channel) for presentation by the application. For example, the map server 22 may be implemented as a web service configured to accept web requests 18 specifying one or more map parameters (e.g., a dimension of the composite map; a center location of the composite map; an area map zoom level for the area map; an area map modality for the area map; at least one other location to include in the area map; at least one route to include in the area map; an inset location map modality for the inset location map; an inset location map zoom level for the inset location map; and an inset position for the inset region of the area map). The map server 22 may therefore generate the area map 56 and/or the inset location map 58, and may render the inset location map 58 over the inset region of the area map 56 to generate the composite map 52, according to the map parameters specified in the programmatic request.

As a fourth example of this second aspect, an embodiment of these techniques may be configured to utilize many types of map sets 24 and maps 26 in generating the area map 54 and/or the inset location map 56. In one such variation, the map set 24 may comprise one or more map tiles that each illustrates a portion of a mapped area. These tiles may take various shapes (e.g., squares, rectangles, circles, or hexagons), and may be aggregated in various ways to generate the composite map 52. For example, the area map 56 may be generated by selecting from the map set 24 at least one map tile that at least partially overlaps the area to be represented by the area map 56, and by compositing the selected map tiles covering the area map 56. Similarly, the inset location map 58 may be generated by selecting from the map set 24 at least one map tile that at least partially overlapping the area to be represented by the inset location map 58, and by compositing the selected map tiles covering the inset location map 58. Moreover, a map composited from tiles in this manner may be processed in other ways to generate the area map 56 and/or the inset location map 58. As a first example, the zoom level illustrated by respective tiles in the map set 24 may illustrate the portion of the mapped area at a particular map tile zoom level that may not match the area map zoom level and/or the inset location map zoom level. Accordingly, the composited map may be scaled to match the area map zoom level and/or the inset location map zoom level. As a second example, one or more dimensions of the composited map may exceed a desired dimension of the area map 56 and/or the inset location map 58; accordingly, the composited map may be trimmed according to an area map dimension and/or an inset location map dimension.

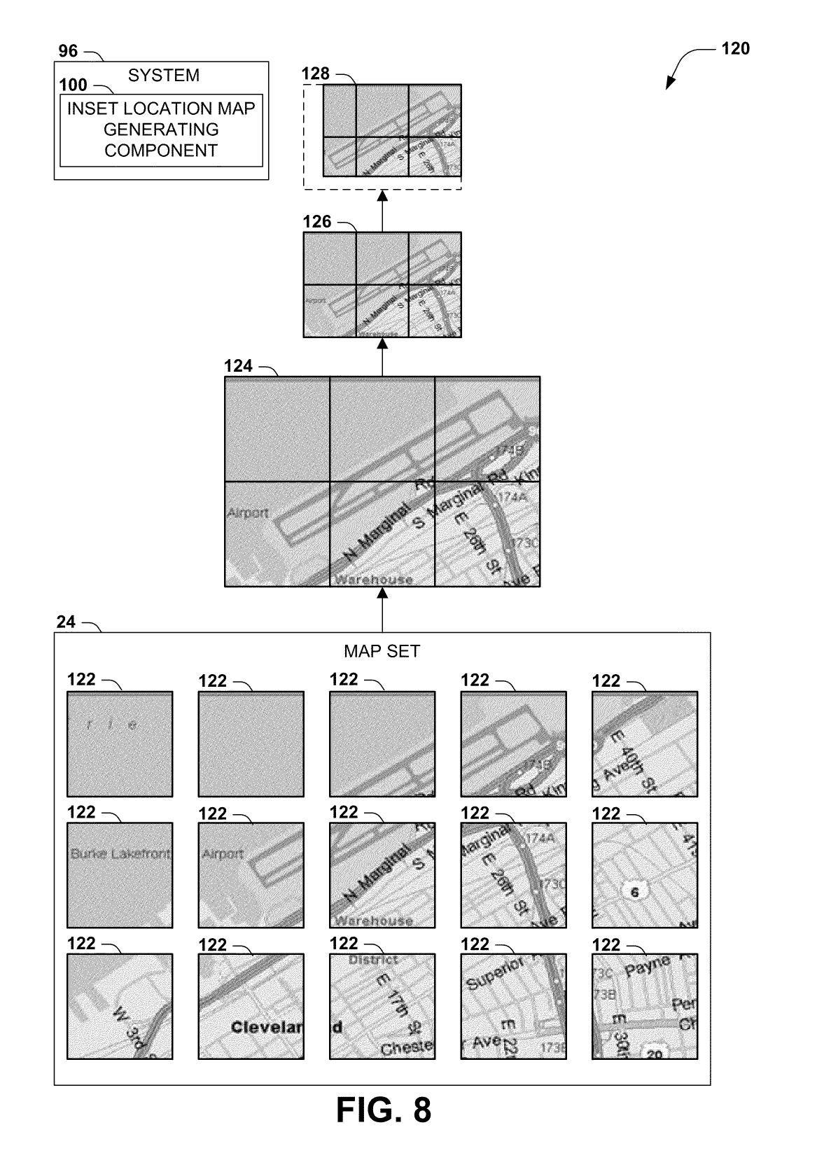

FIG. 8 presents an exemplary scenario 120 illustrating the compositing of an inset location map 58 representing a location 16 (e.g., an airport in Cleveland, Ohio) based on a map set 24 comprising a set of map tiles 122, where respective map tiles 122 illustrate a portion of the mapped area (e.g., a map of downtown Cleveland) at a particular map tile zoom level. A component of an embodiment of these techniques (such as the inset location map generating component 100 of the exemplary system 96 of FIG. 6) may generate an inset location map 58 of a location 16 by selecting map tiles 122 that together illustrate the location 16. The selected map tiles 122 may then be composited to form a composited inset location map 124 that illustrates the location 16. However, the composited inset location map 124 may be further processed to match various parameters of the requested inset location map 58. As a first example, the map tile zoom level may be higher than the inset location map zoom level, so the composited inset location map 124 may be scaled to generate a scaled composited inset location map 126 having a zoom level that matches the inset location map zoom level. For example, if the map tiles 124 illustrate the mapped area at a scale of two kilometers per 100 pixels, and if the requested inset location map 124 has an inset location map zoom level of four kilometers per 100 pixels, the width and height of the composited map 124 may each be downscaled by 50% to achieve the requested inset location map zoom level). As a second example, even after scaling, the scaled composited inset location map 126 may have different dimensions than those of the requested inset location map 58 (e.g., a different height or width). Therefore, the scaled composited inset location map 126 may be trimmed to generate a trimmed and scaled composited inset location map 128 the requested dimensions of the inset location map 58. For example, a request 14 may specify that the inset location map 58 of an airport location 16 is to be trimmed close to the boundaries of the airport, and the scaled composited inset location map 126 may be accordingly trimmed to satisfy the request 14. Similar processing of map tiles 122 of the map set 24 may be performed (e.g., by the area map generating component 98 of the exemplary system 96 of FIG. 6) in order to generate an area map 56 from the map tiles 122 of the tile set 24. In this manner, an embodiment of these techniques may utilize the map tiles 122 of the tile set 24 to generate the composite map 52. However, those of ordinary skill in the art may devise many architectures to generate and present maps to users 12 in accordance with the techniques presented herein.

A third aspect that may vary among embodiments of these techniques relates to the types of area map 56 and inset location maps 58 that may be generated from the map set 24. As a first example, the area map zoom level and the inset location map zoom level may be selected in many ways. For example, either zoom level may be specified by the user 12 or an application that is programmatically requesting the composite map 52. If either zoom level is not specified, a default area map zoom level and/or default inset location map zoom level may be utilized. The zoom levels may also be selected to include particular features in the area illustrated by each map. For example, if the request 14 specifies a set of locations, the area map zoom level may be selected to include all of the locations 16 in the location set. Similarly, the inset location map zoom level may be selected according to a dimension of the location 16; e.g., if the boundaries of the area illustrating the location 16 within the map set 24 may be determined, then the inset location map zoom level may be selected (while remaining higher than the area map zoom level) such that the entire area of the location 16 is illustrated in the inset location map 58 within the inset region.

As a second example of this third aspect, the composite map 52 may be rendered, adjusted, and/or annotated in various ways specified by the user 12, an application that programmatically requests the composite map 52, and/or by default. As a first example, an embodiment of these techniques may render on the area map 56 one or more markers 36 that indicate the locations 16 of a location set. As a second example, an embodiment of these techniques may be configured to render on the area map 56 an inset location map indicator that indicates the area presented in the inset location map 58 (e.g., a rectangle rendered on the area map 56 that illustrates the boundaries of the mapped area illustrated in the inset location map 58). As a third example, the inset region of the inset location map 58 may be specified by the user 12 or an application programmatically requesting the composite map 52, and an embodiment of these techniques may render the inset location map 58 over the area map 56 at the inset region so specified. Those of ordinary skill in the art may devise many techniques for generating a composite map 52 according to the techniques presented herein.

A fourth aspect that may vary among embodiments of these techniques relates to the manner of presenting the composite map 52 to the user 12. As a first example, an embodiment of these techniques may display the composite map 52 on a display component 20 of a device 18 operated by the user 12, or may print the map on a printer device attached to the device 18. As a second example, an embodiment of these techniques may store the composite map 52 as a file in a file store, an object in an object store, or a database object in a database system. As a third example, an embodiment of these techniques may deliver the composite map 52 to the user 12 over a network (such as the internet, a wired or wireless local area network, or a cellular network). Those of ordinary skill in the art may devise many techniques for presenting the composite map 52 to the user 12 in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

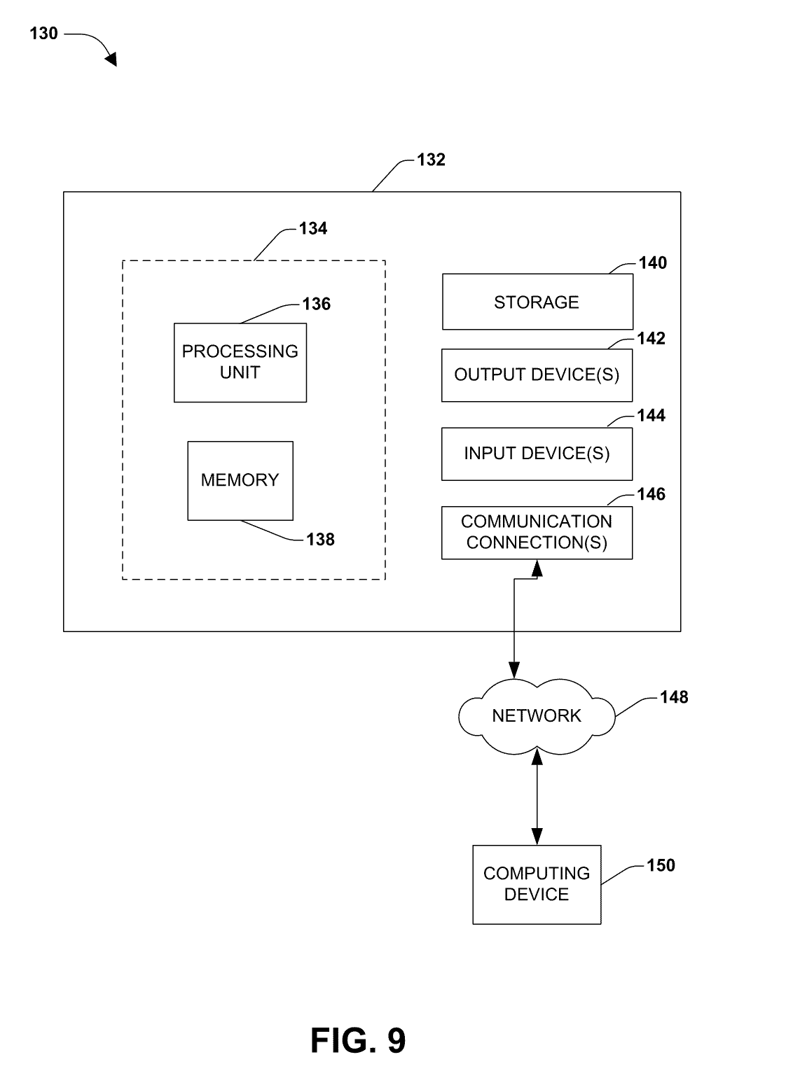

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (presented below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 130 comprising a computing device 132 configured to implement one or more embodiments provided herein. In one configuration, computing device 132 includes at least one processing unit 136 and memory 138. Depending on the exact configuration and type of computing device, memory 138 may be volatile (such as RAM, for example), non-volatile (such as ROM, flash memory, etc., for example) or some combination of the two. This configuration is illustrated in FIG. 9 by dashed line 134.

In other embodiments, device 132 may include additional features and/or functionality. For example, device 132 may also include additional storage (e.g., removable and/or non-removable) including, but not limited to, magnetic storage, optical storage, and the like. Such additional storage is illustrated in FIG. 9 by storage 140. In one embodiment, computer readable instructions to implement one or more embodiments provided herein may be in storage 140. Storage 140 may also store other computer readable instructions to implement an operating system, an application program, and the like. Computer readable instructions may be loaded in memory 138 for execution by processing unit 136, for example.

The term “computer readable media” as used herein includes computer storage media. Computer storage media includes volatile and nonvolatile, removable and non-removable media implemented in any method or technology for storage of information such as computer readable instructions or other data. Memory 138 and storage 140 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 132. Any such computer storage media may be part of device 132.

Device 132 may also include communication connection(s) 146 that allows device 132 to communicate with other devices. Communication connection(s) 146 may include, but is not limited to, a modem, a Network Interface Card (NIC), an integrated network interface, a radio frequency transmitter/receiver, an infrared port, a USB connection, or other interfaces for connecting computing device 132 to other computing devices. Communication connection(s) 146 may include a wired connection or a wireless connection. Communication connection(s) 146 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 132 may include input device(s) 144 such as keyboard, mouse, pen, voice input device, touch input device, infrared cameras, video input devices, and/or any other input device. Output device(s) 142 such as one or more displays, speakers, printers, and/or any other output device may also be included in device 132. Input device(s) 144 and output device(s) 142 may be connected to device 132 via a wired connection, wireless connection, or any combination thereof. In one embodiment, an input device or an output device from another computing device may be used as input device(s) 144 or output device(s) 142 for computing device 132.

Components of computing device 132 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 132 may be interconnected by a network. For example, memory 138 may be comprised of multiple physical memory units located in different physical locations interconnected by a network.

Those skilled in the art will realize that storage devices utilized to store computer readable instructions may be distributed across a network. For example, a computing device 150 accessible via network 148 may store computer readable instructions to implement one or more embodiments provided herein. Computing device 132 may access computing device 150 and download a part or all of the computer readable instructions for execution. Alternatively, computing device 132 may download pieces of the computer readable instructions, as needed, or some instructions may be executed at computing device 132 and some at computing device 150.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting a map including a location to a user on a device having a processor and a map set, the method comprising:
executing on the processor instructions configured to:
using the map set, generate an area map at an area map zoom level and including the location;
using the map set, generate an inset location map at an inset location map zoom level higher than the area map zoom level and including the location;
generate a composite map by rendering the inset location map over an inset region of the area map; and
present the composite map to the user.

2. The method of claim 1, the composite map comprising a static composite map.

3. The method of claim 2, the instructions configured to associate with the composite map a reference to a dynamic map including the location.

4. The method of claim 1, the area map zoom level specified by the user.

5. The method of claim 1:
the location included in a location set comprising at least one other location, and
the area map zoom level selected to include the locations of the location set.

6. The method of claim 1, the inset location map zoom level specified by the user.

7. The method of claim 1:
the inset location map zoom level not specified by the user, and selected according to a default inset location map zoom level.

8. The method of claim 1, the inset location map zoom level selected according to a dimension of the location.

9. The method of claim 1:
the location associated with at least one route, and
the instructions configured to render at least one route on the area map.

10. The method of claim 9:
the location associated with at least one routing direction in a route, and
the inset location map zoom level selected to illustrate the routing direction of the location in the route.

11. The method of claim 1, the instructions configured to render on the area map an inset location map indicator indicating an area presented in the inset location map.

12. The method of claim 1:
the area map generated according to an area map modality, and
the inset location map generated according to an inset location map modality.

13. The method of claim 1, the inset region of the area map specified by the user.

14. A system configured to, using a map set, present a map including a location to a user, the system comprising:
an area map generating component configured to, using the map set, generate an area map at an area map zoom level and including the location;
an inset location map generating component configured to, using the map set, generate an inset location map at an inset location map zoom level higher than the area map zoom level and including the location;
a composite map generating component configured to generate a composite map by rendering the inset location map over an inset region of the area map; and
a composite map presenting component configured to present the composite map to the user.

15. The system of claim 14, the system comprising a programmatic interface configured to generate the composite map in response to a request of the user specifying the location as a parameter of the request.

16. The system of claim 15:
the system configured to accept at least one other map parameter of the request selected from a set of map parameters comprising:
a dimension of the composite map,
a center location of the composite map,
an area map zoom level for the area map,
an area map modality for the area map,
at least one other location to include in the area map,
at least one route to include in the area map,
an inset location map modality for the inset location map,
an inset location map zoom level for the inset location map, and
an inset position for the inset region of the area map;
the area map generating component configured to generate the area map according to the at least one map parameter of the request;
the inset location map generating component configured to generate the inset location map according to the at least one map parameter of the request; and
the composite map generating component configured to generate the composite map comprising: generating the composite map by rendering the inset location map over an inset region of the area map according to the at least one map parameter of the request.

17. The system of claim 14:
the map set comprising at least one map tile illustrating a portion of a mapped area;
generating the area map comprising:
selecting from the map set the at least one map tile at least partially overlapping the area map, and
generating the area map by compositing selected map tiles covering the area map;
generating the inset location map comprising:
selecting from the map set the at least one map tile at least partially overlapping the inset location map, and
generating the inset location map by compositing selected map tiles covering the inset location map.

18. The system of claim 17, generating the area map comprising: scaling the area map according to the area map zoom level.

19. The system of claim 17, generating the area map comprising: trimming the area map according to at least one area map dimension.

20. A computer-readable storage medium comprising instructions that, when executed by a processor of a device having access to a map set comprising at least one map tile illustrating a portion of a mapped area, present to a user of the device a static map including a location set comprising at least one location by:
generating an area map according to an area map modality at an area map zoom level selected to include the locations of the location set by:
selecting from the map set the at least one map tile at least partially overlapping the area map,
generating the area map by compositing selected map tiles covering the area map,
scaling the area map according to the area map zoom level, and
trimming the area map according to at least one area map dimension;
generating an inset location map according to an inset location map modality at an inset location map zoom level selected according to a dimension of the location, the inset location map zoom level higher than the area map zoom level, by:
selecting from the map set the at least one map tile at least partially overlapping the inset location map,
generating the inset location map by compositing selected map tiles covering the inset location map, and
scaling the inset location map according to the inset location map zoom level;
generating a composite map by rendering the inset location map over an inset region of the area map specified by the user;
rendering on the area map an inset location map indicator indicating an area presented in the inset location map;
associating with the composite map a reference to a dynamic map including the location; and
presenting the composite map to the user.
